(19) United States
(12) Patent Application Publication
(10) Pub. No.: US 2014/0290123 A1
(43) Pub. Date: Oct. 2, 2014

(54) MULTI-LAYER TRAP SYSTEM FOR DISEASE PREVENTION

(71) Applicant: David W. DUFF, Amherst, NH (US)

(72) Inventor: David W. DUFF, Amherst, NH (US)

(21) Appl. No.: 14/242,410

(22) Filed: Apr. 1, 2014

Related U.S. Application Data
(60) Provisional application No. 61/853,194, filed on Apr. 1, 2013.

(51) Int. Cl. A01M 1/02; A01M 1/14

(52) U.S. Cl. CPC A01M 1/02; A01M 1/14
USPC 43/114

(57) ABSTRACT

Techniques for disease prevention using insect traps are provided. A refillable, attachable and wearable trap system with ability to attract, ensnare, immobilize, or kill a tick or other targeted walking arachnid or insect present on the surface of a host mammal may include a housing with a cavity, such that the housing contains a refillable immobilizing layer or substrate that includes a chemical-based arachnid or insect attractant. The housing may contain a receiver base layer to allow for temporary insertion or attachment of immobilizing layer or substrate. A porous outer layer may cover the housing, and a lower receiver base layer may be co-joined to forms cavity. The housing receiver base layer may include an insertion guide or track for temporarily holding the refillable immobilizing layer in place. The trap system may also include a refillable emitter module for housing a chemical-based arachnid or insect attractant.

### CROSS REFERENCE TO RELATED APPLICATIONS

This application claims the benefit of U.S. Provisional Application No. U.S. 61/853,194, filed Apr. 1, 2013 and entitled “Attachable and wearable patch system for disease prevention against ticks and other walking arachnids or insects.”

### BACKGROUND

The Arthropoda phylum of the animal kingdom has exoskeletons, jointed appendages, a body formed of a number of segments. Arthropods are members of the phylum Arthropoda and include the insects, arachnids and crustaceans. Many insects and arachnids are known to spread harmful diseases to both humans and animals. Many of these species are considered to be pests as well as to carry harmful diseases. The transmission of disease by Arthropods is a health concern to humans and animals world-wide. Diseases such as Lyme disease, human anaplasmosis, babesiosis, rickettsial diseases including Rocky Mountain spotted fever and typhus, ehrlichiosis, Powassan virus and tularemia are some diseases known to be transmitted by insects and arachnids. Preventative measures typically include toxic pesticides and insecticides.

### SUMMARY

An example of a multi-layer trap system for disease prevention includes a substrate layer and an immobilizing layer disposed on the substrate layer and including an immobilizing compound including at least one trapping structure and an attractant. The multi-layer trap system may further include a conveyance layer disposed on or about the immobilizing layer, the conveyance layer being configured to permit an insect to travel through the conveyance layer to the immobilizing layer.

Implementation of the multi-layer trap system may include one or more of the following features. A conveyance layer may be a flexible polymer and may have trap openings. The multi-layer trap system may include at least one trapping structure including dimensionally reducing or confining tunnels. The at least one trapping structure may include nautilus shapes. The multi-layer trap system may include a base with an insertion guide, the substrate layer being configured to be attached to the base via the insertion guide. The substrate layer may include a replacement tab. The multi-layer trap system may have a clamshell case that includes openings, and the substrate layer and the immobilizing layer may be disposed within the clamshell case. The multi-layer trap system may include a barrel trap housing, the substrate layer and the immobilizing layer being disposed within the barrel trap housing. The multi-layer trap may include an emitter disposed on the barrel trap housing.

An example of a flexible multi-layer trap system for disease prevention includes a flexible band base having a first side and a second side, a substrate layer secured to the first side of the flexible band base, an immobilizing layer disposed on the substrate layer, an immobilizing compound including at least one trapping structure, an attractant, and a flexible conveyance layer disposed on or about the immobilizing layer.

Implementation of such a flexible multi-layer trap system may include one or more of the following features. The flexible band base may be an openable annular ring. The flexible band base may be integrated into a garment. The flexible multi-layer trap system may include an adhesive disposed on the second side of the flexible band base, the adhesive being configured to contact the skin of a user when the multi-layer trap system is worn by the user.

An example of a refillable, attachable, and wearable trap system with ability to attract, ensnare, immobilize, or kill a tick or other targeted walking arachnid or insect present on a surface of a host mammal including a housing with a cavity, the housing containing a refillable immobilizing layer or substrate that includes a chemical-based arachnid or insect attractant, the housing containing a receiver base layer that allows for temporary insertion or attachment of the refillable immobilizing layer or substrate, the housing having a porous outer layer or cover and a lower receiver base layer which when co-joined forms a cavity, the receiver base layer having an insertion guide or track for temporarily holding the refillable immobilizing layer in place, the housing containing a refillable emitter module for containing a chemical-based arachnid or insect attractant and the housing exterior having a mechanical fastener for attaching to a carrier.

Implementations of the wearable trap system may include one or more of the following features. The refillable immobilizing layer may contain an adhesive compound. The chemical-based arachnid or insect attractant within the refillable immobilizing layer may contain a single chemical compound or any combination of the following naturally occurring chemical compounds found in or produced by mammals: salt, water, acetone, nitric oxide, acetic acid, guanine, xanthine, hypoxanthine, adenine, inosine, 8-azaguanine, squalene, 2-nitrophenol, benzoic acid, butanoic acid, methylbutanoic acid, methylpropanoic acid, pentanoic acid, nonanoic acid, methyl salicylate, salicylaldehyde, hematin, carbon dioxide, octenol, ammonium carbonate, 2,6-dichlorophenol, phenylacetaldehyde, amino acids, urea, uric acid, benzaldehyde, hexanal, heptanal, pyruvate, 3-pentanone. A typical ratio of chemical-based arachnid or insect attractant within the refillable immobilizing layer may be 1-2 parts octenol, 5-10 parts squalene, 5-10 parts nitrophenol, 10-20 parts methyl salicylate, 10-20 parts butanoic acid, 10-20 parts nononoic acid, 10-20 parts guanine, 10-20 parts xanthine. The chemical-based arachnid or insect attractant may be spatially patterned in two dimensions within the refillable immobilizing layer with an inkjet drop on demand deposition application or other spatially specific deposition means. The refillable immobilizing layer with or without chemically-based arachnid or insect attractant may be spatially patterned in three dimensions with an inkjet drop on demand deposition application or other spatially specific deposition means.

Items and/or techniques described herein may provide one or more of the following capabilities, as well as other capabilities not mentioned.

Wearing the multi-layer trap system can eliminate or reduce the risk of infection or illness by trapping walking insects such as spiders, ticks and other insects that may carry disease. The multi-layer trap system can be worn as a patch or as a band and can be integrated onto clothing and animal gear or stand alone. The immobilizing layer and optional attractant are replaceable. Replaceable layers and housings can be customized according to geographical area. These and other capabilities of the invention, along with the invention itself, will be more fully understood after a review of the following figures, detailed description, and claims.

### BRIEF DESCRIPTIONS OF THE DRAWINGS

In the appended figures, similar components and/or features may have the same reference label.

FIGS. 1A and 1B are schematic diagrams of a side view and a top view of a multi-layer trap system.

FIGS. 1C-1F are schematic diagrams of immobilizing layer configurations.

FIG. 2 is a schematic diagram of an example of a wearable multi-layer trap system.

FIGS. 3A and 3B are schematic diagrams of a side view and a top view of an example of a flexible multi-layer trap system.

FIG. 3C is a schematic diagram of a side view of a flexible multi-layer trap system as secured to a mammal limb.

FIGS. 4A and 4B are schematic diagrams of a perspective view and an exploded view of an example of a self-contained trap.

FIG. 4C is a schematic diagram of exploded views of a self-contained trap including a mounting layer.

FIGS. 5A-C are schematic diagrams of self-contained traps.

FIG. 6 is a schematic diagram of an animal harness with integrated multi-layer trap systems.

FIG. 7 is a schematic drawing of a clamshell case.

FIG. 8 is a schematic drawing of side view of an example of a closed clamshell case.

FIG. 9 is a block diagram of a method of use of the multi-layer trap system.

### DETAILED DESCRIPTION

Multi-layer trap systems and methods are discussed herein for immobilizing and/or trapping insects and/or arachnids. The systems and methods discussed below are examples, however, and not limiting of the invention as other implementations in accordance with the disclosure are possible. For example, a multi-layer trap system may include a conveyance layer, an immobilizing layer, and a substrate layer. The term layer, as used herein, refers to physical layer structures and/or to functional aspects of components within systems discussed. While individual layers are shown, two or more of the layers may be combined in single structure. The immobilizing layer may be replaceable and disposable. The multi-layer trap system may further include a cover and/or an attractant. The attractant may be substantially composed of naturally occurring chemical compounds, i.e., chemicals found on and/or produced naturally by mammals. The multi-layer trap system may be refillable, for example, with the replaceable immobilizing layer. Further, the multi-layer trap system may be wearable by humans and/or other mammals (e.g., household pets, farm animals, etc.) and may be securable to apparel, animal carriers, bedding, etc.

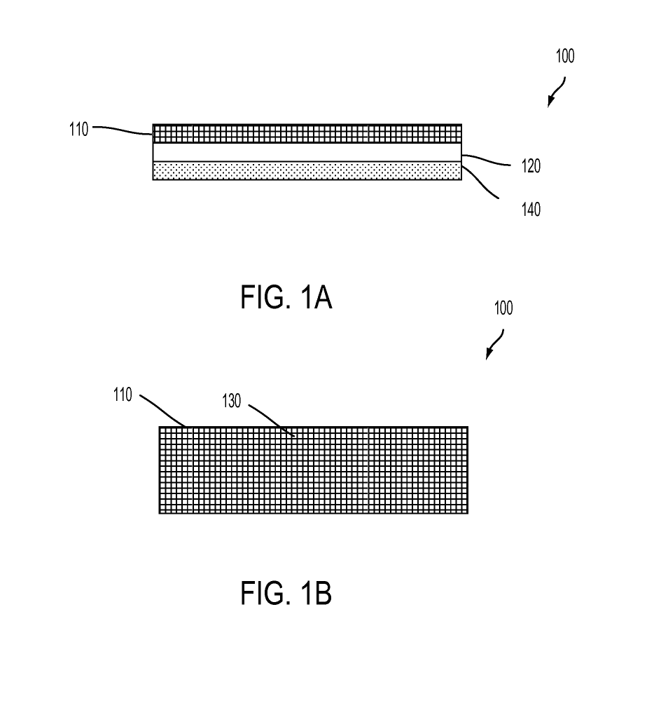

Referring to FIGS. 1A and 1B, a side view and a top view, respectively, of a multi-layer trap system 100 is shown. FIGS. 1A and 1B are only examples and not limiting of the invention as other shapes, geometries, configurations, and layers in accordance with the disclosure are possible. The multi-layer trap system 100 may be altered, e.g., by having components and layers added, removed, combined, reshaped or rearranged. The multi-layer trap system 100 includes a substrate layer 140, an immobilizing layer 120, and may also include a conveyance layer 110. At least any or all of the layers may be disposable and/or replaceable. Layer thicknesses may vary based on the intended application and insect to be trapped, but in general are in a range of 0.02 cm to 2.54 cm.

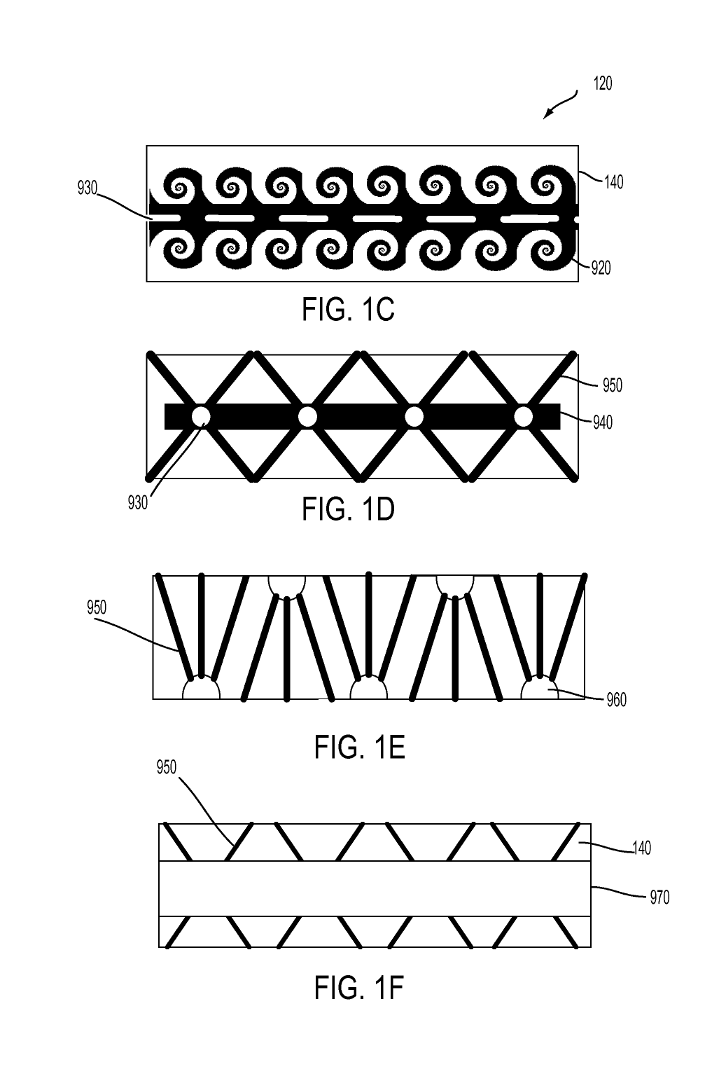

The substrate layer 140 forms a bottom layer of the multi-layer trap system 100 and supports the immobilizing layer 120 and the conveyance layer 110. The substrate layer 140 may be substantially composed of a polymer, polymer blend, a fabric, or combinations thereof. The substrate layer 140 may be rigid, flexible and/or extendable. The dimensions of the substrate layer 140 are not limiting and may vary based on the intended application of the multi-layer trap system 100. In an example, the substrate layer 140 may have a thickness of 0.02 cm-0.32 cm and a width of 0.16 cm to 5 cm. A bottom surface of the substrate layer 140 may include an adhesive and/or one or more mechanical fasteners (not shown) as appropriate of the particular application. The mechanical fasteners may be, for example, Velcro®, straps, bands, bandages, pins, etc. The adhesive and/or mechanical fastener may secure the multi-layer trap system 100, for example, to an article of human and/or animal apparel (e.g., clothing, a collar, a harness, a muzzle, leggings, footwear, headwear, etc.), to skin, to animal fur, to a wearable band, to a trap housing, to a pendant, to an object adorning and/or transported by a human or other mammal, etc. As further examples, the adhesive and/or mechanical fastener may secure the multi-layer trap system 100 to bedding, flooring, a mat, a pillow, a blanket, housing, a transport system, a carrier and/or any other physical environment used by a human or other mammal for resting, sleeping, and/or transport. In an embodiment, as described below with regard to FIG. 2, the adhesive layer and/or mechanical fasteners may secure the substrate layer to a base 210. Alternatively, an insertion guide or track may be attached to the base 210. The bottom surface of the substrate layer 140, may include a rail (not shown) configured to slide into the insertion guide or track and secure the substrate layer 140 to the base 210 for removing or replacing the multi-layer trap system 100.

The immobilizing layer 120 is in contact with and partially or fully covers the top surface of the substrate layer 140 and forms an intermediate layer between the substrate layer 140 and the conveyance layer 110 in some embodiments. The immobilizing layer 120 is configured to trap the insects and/or arachnids. The dimensions of the immobilizing layer 120 may vary based on the embodiment. In an example, the immobilizing layer 120 may have a width of 0.15 cm to 2.54 cm and a thickness of 0.02 cm to 0.32 cm.

The immobilizing layer 120 may include one or more of an immobilizing compound, an attractant, and trapping structures. The immobilizing compound may be, for example, a solid, a liquid, or a gel and may include an adhesive compound. Examples of immobilizing compounds include thermoplastic polyurethanes, polybutadiene-derived polyurethanes, ethylene-vinyl acetates (EVA), and any number of hot melt adhesives may be used. In addition, natural adhesives such as those derived from gum resins (rosin), linseed oil, and wax may also be used as the immobilizing layer. The attractant may include chemicals that can lure and attract insects and/or arachnids to the immobilizing layer 120 and/or the substrate layer 140. The attractant may be constitutive of the immobilizing compound or may be on the surface of the immobilizing compound (e.g., a deposited layer). The attractant may be a chemically-based arachnid or insect attractant. The attractant may include naturally occurring chemical compounds found in or produced by mammals, for example, salt, water, acetone, nitric oxide, acetic acid, guanine, xanthine, hypoxanthine, adenine, inosine, 8-azaguanine, squalene, 2-nitrophenol, benzoic acid, butanoic acid, methylbutanoic acid, methylpropanoic acid, pentanoic acid, nonanoic acid, methyl salicylate, salicylaldehyde, hematin, carbon dioxide, octenol, ammonium carbonate, 2,6-dichlorophenol, phenylacetaldehyde, amino acids, urea, uric acid, benzaldehyde, hexanal, heptanal, pyruvate, 3-pentanone etc., or combinations thereof The constituent ratio of attractants within the immobilizing layer 120 or the substrate layer 140 may be, for example, 1-2 parts octenol, 5-10 parts squalene, 5-10 parts nitrophenol, 10-20 parts methyl salicylate, 10-20 parts butanoic acid, 10-20 parts nononoic acid, 10-20 parts guanine, and 10-20 parts xanthine. An example of a trapping structure may include walls, tunnels, caves, etc. formed, at least in part, by three-dimensional patterned configurations of the immobilizing layer 120. The trapping structures may direct insects and/or arachnids to a region of one of the immobilizing layer 120 that traps the insects and/or arachnids physically and/or chemically (i.e., due to the presence of the immobilizing compound). For example, walls may form a tunnel extending through the thickness of the immobilizing layer 120. The trapping structure may include dimensionally reducing or confining tunnels.

Referring to FIGS. 1C-1F, schematic diagrams of examples of immobilizing layer configurations are shown. FIGS. 1C-1F are only examples and are not limiting of the invention as other shapes, geometries, and configurations in accordance with the disclosure are possible. The immobilizing compound and/or the attractant may be deposited on the substrate 140 uniformly or in a two or three dimensional spatial pattern or configuration to form the immobilizing layer. For example, the immobilizing compound and the attractant may be spatially patterned in two or three dimensions with an inkjet drop on demand deposition application or other spatially specific deposition method. Pattern geometries may include different sizes and shapes based on the insects and arachnids of the geographical region of the world in which the multi-layer trap system 100 will be used.

For example, as shown schematically in FIG. 1C, a nautilus immobilizing layer configuration 920 of the immobilizing layer 120 includes a pattern of variable width. The immobilizing compound and/or the attractant may be constitutive of the patterned immobilizing layer (i.e., the immobilizing compound and/or the attractant may be deposited in the nautilus immobilizing layer configuration 920). Additionally, portions of the immobilizing layer 120 may be void of immobilizing compound and/or attractant. Alternatively or additionally, the attractant 930 may form an attractant pattern 930 on the surface of the immobilizing layer configuration 920. For example, as shown schematically in FIG. 1D, a bar immobilizing layer configuration 940 is shown. An attractant configuration 930 is disposed on the bar immobilizing layer 940 and wall configurations 950 are used to guide the insects and/or arachnids to the bar immobilizing layer 940. For example, as shown schematically in FIG. 1E, a spot immobilizing layer configuration 960 is shown. An attractant is integrated into the spot immobilizing layer 960 and wall configurations 950 are used to guide the insects and/or arachnids to the spot immobilizing layer 960. In an example, the wall configurations 950 are constructed to create an increasingly narrowing space as the distance to the attractant decreases. The dimensions of the narrowing space can be designed to inhibit an insects ability to maneuver (i.e., turn around) once in the space. In another example, as shown schematically in FIG. 1F, the immobilizing layer 120 may include wall configurations 950 to guide insects and/or arachnids to a three dimensional structure 970. An immobilizing compound, housed in the three dimensional structure 970, may include attractants.

Referring back to FIGS. 1A and 1B, a surface of the conveyance layer 110 may form a top layer of the multi-layer trap system 100 in some embodiments. The conveyance layer 110 may be disposed on or about the immobilizing layer 120 but does not need to be in contact with the immobilizing layer 120. For example, the conveyance layer 110 may form a shell structure over the immobilizing layer 120. The conveyance layer 110 includes trap openings 130, starting at the top surface of the conveyance layer 110 and extending through to the bottom surface of the conveyance layer 110, configured to allow passage of the insects and/or arachnids. The size and/or the pattern of the trap openings 130 may enable unimpeded passage of the insects and/or arachnids. For example, the size of the trap openings 130 may be based on the size of the particular insects and/or arachnids in a particular region of the world in which the multi-layer trap system 100 is in use. The trap openings 130 may include a taper such that there is a larger dimension at an outer surface of the conveyance layer 110 (i.e., an entrance to the multi-layer trap system 100) and a smaller dimension proximate to an interface between the conveyance layer 110 and the immobilizing layer 120 (i.e., inside the multi-layer trap system). In some examples, the trap openings 130 may include one or more barbs (not shown) extending inwards from the trap openings 130 configured to prevent and/or discourage the insect and/or arachnid from exiting the conveyance layer 110. For example, trap openings 130, may be circular, rectangular, in the form of slits or any regular or irregular shape. The material of the conveyance layer 110 may be, for example, a metal, a fabric, a polymer (rigid or flexible), or combinations thereof. The conveyance layer 110 may be flexible. The conveyance layer 110 may be configured, as a mesh, a fibrous matrix, a woven matrix, a cross linked matrix, a porous matrix etc. In some examples, the conveyance layer 110 may include a protective cover layer (not shown). The cover layer may be disposed at the surface of the conveyance layer 110 and may form the surface of the multi-layer trap system 100. The cover layer may have entry ways to allow insects and/or arachnids to enter the trap from the top of the cover or the sides of the multi-layer trap system 100. The cover layer may be transparent or semi-transparent and may allow verification of trapped insects and/or arachnids. For example, the insects and/or arachnids trapped in the multi-layer trap system 100 may be viewed through the cover layer. In some embodiments, a conveyance layer is not used, for example, the multi-layer trap system 100 includes the substrate layer 140 and the immobilizing layer 120.

Referring to FIG. 2, an example of a wearable multi-layer trap system 200 with base 210 and replacement tab 220 is shown. FIG. 2 is only an example and is not limiting of the invention as other shapes, configurations, and layers in accordance with the disclosure are possible. For example, the wearable multi-layer trap system 200 includes the multi-layer trap system 100, the base 210 and a replacement tab 220. The multi-layer trap system 100 is substantially as described above with regard to FIG. 1A.

The base 210 may be an adhesive layer and may attach the wearable multi-layer trap system 200, for example, to an article of clothing for a person or animal, to the skin of a human or fur of animal, or to a band or trap. Alternatively, the base 210 may include a mechanical fastener (not shown) to secure the wearable multi-layer trap system 200 to a mammal's skin, fur, collar, harness, muzzle, clothing, leggings, garment, compression band, pendant, and/or any other object adorning or transported by the mammal As other examples, the mechanical fastener may secure the wearable multi-layer trap system 200 to bedding, flooring, a mat, a pillow, a blanket, housing, a transport system, a carrier and/or any other physical environment used by a mammal for resting, sleeping, and/or transport. The mechanical fastener may be further configured to secure the wearable multi-layer trap system 200 to human skin, human hair, clothing, garments, footwear, headwear, a pendant, a compression band, and/or any other object adorning or transported by a human. The mechanical fastener may be, for example, an adhesive, Velcro®, strap, band, bandage, elastic, pin etc. The area of the base 210 may be less than, substantially equal to, or greater than the area of the substrate layer 140.

The replacement tab 220 allows replacement and/or disposal of the multi-layer trap system 100. The replacement tab 220 may be substantially composed of a polymer, fabric, or metal and is secured to the multi-layer trap system 100. The replacement tab 220 may be affixed to the multi-layer trap system 100 substrate layer 140 (e.g., with an adhesive) or the replacement tab 220 and the multi-layer trap system 100 may be fabricated, for example, machined or molded, as a singular component. The replacement tab 220 may enable the multi-layer trap system 100 to be replaced in its entirety by allowing the multi-layer trap system 100 to be peeled off of the base 210. Alternatively, the multi-layer trap system 100 may slide along the insertion guide or track located on the base 210 to secure and/or remove the multi-layer trap system 100 from the base 210.

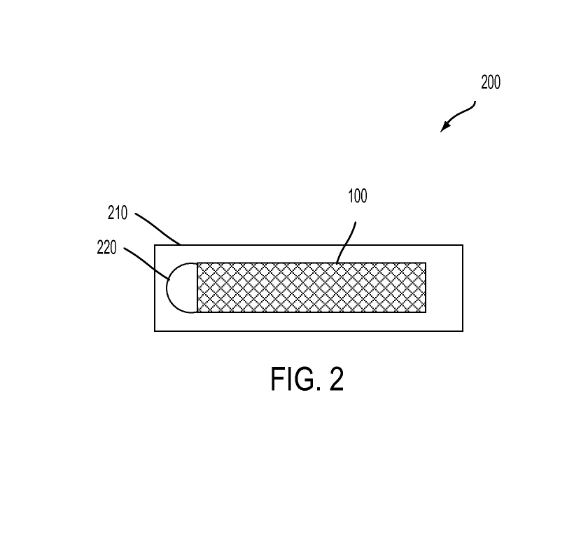

Referring to FIGS. 3A and 3B, a side view and a top view, respectively, are shown of an example of a flexible multi-layer trap system 300. FIGS. 3A and 3B are only examples and are not limiting of the invention as other shapes, configurations, and layers in accordance with the disclosure are possible. The flexible multi-layer trap system 300 includes the multi-layer trap system 100 and a flexible band base 310. The flexible multi-layer trap system 300 is also extendable. The flexible band base 310 may be substantially composed of an elastic material having an elongation of 100% to 300%. The base band 310 may include an attachment mechanism (e.g., an adhesive, Velcro®, strap, band, bandage, elastic, pin, a buckle etc.) configured to conjoin a first end of the base band 310 to a second and opposite end of the flexible band base 310 in order to form an openable annular ring (e.g., a 360 degree band). For example, the 360 degree band may wrap around and encircle a mammal's leg, arm, or other body part. Alternatively, the band base 310 may form a continuous annular ring. For example, the continuous annular ring may slip onto an end of the mammal's leg, arm or other body part. An example of the flexible multi-layer trap system 300 secured to a mammal limb 320 is shown schematically in FIG. 3C. Alternatively or additionally, the flexible multi-layer trap system 300 can also be integrated into a carrier such as compression leggings or other garments to provide a customized, integrated application. Insects or arachnids may traverse the band base 310 and enter the multi-layer trap system 100 through the conveyance layer 110. An adhesive may secure the substrate layer 140 to the band base 310. Additionally or alternatively, the substrate layer 140 may be constitutive of the band base 310. The conveyance layer 110 may be removed from the multi-layer trap system 100 prior to application to the band base 310 or applied to the immobilizing layer 120 in-situ. To accommodate various diameters and circumferences of the flexible multi-layer trap system 300, the length of the immobilizing layer 120 and/or the receiver track may be variable to ensure a complete 360 degree application.

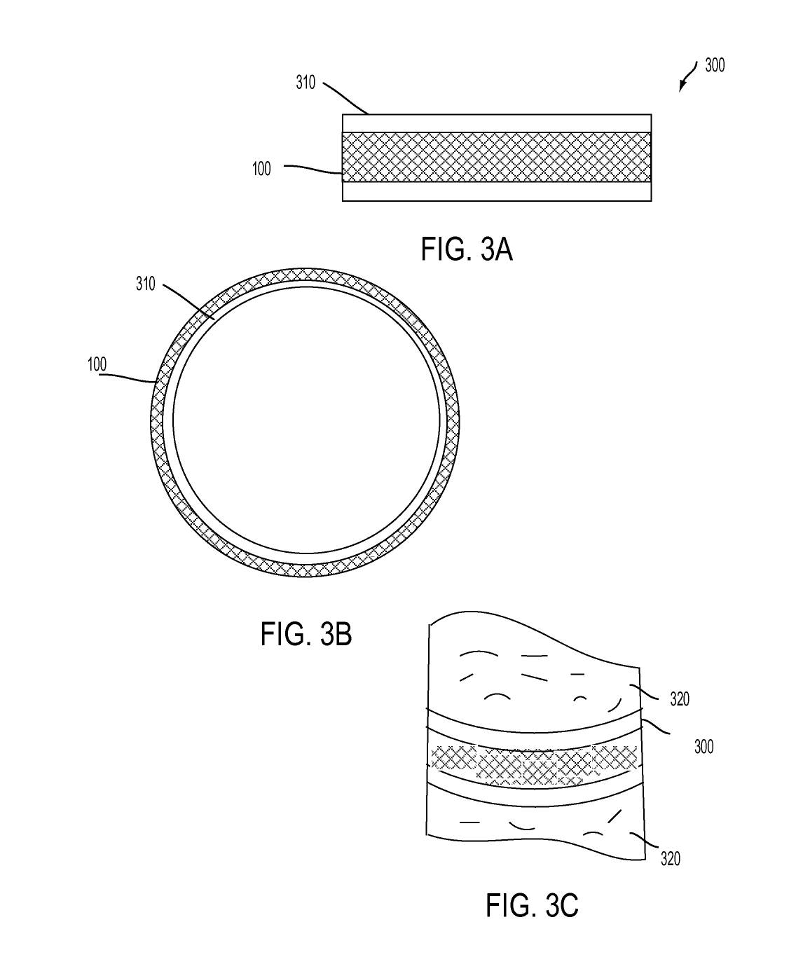

Referring to FIGS. 4A and 4B, schematic diagrams of a perspective view and an exploded view, respectively, of an example of a self-contained trap 400 are shown. FIGS. 4A and 4B are examples only and not limiting of the invention as other configurations in accordance with the disclosure are possible. The self-contained trap 400 may be altered, e.g., by having components added, removed, reshaped or rearranged. The self-contained trap 400 includes the container 420, a container top 410, a circular multi-layer trap system 450, a container base 440, and one or more container openings 430. The container 420 may be an annular shaped ring. The container top 410 is secured to a top side of the container 420 and the container base 440 is secured to a bottom side of the container 420 such that the container base 440 is parallel to the container top 410. The circular multi-layer trap system 450 contains layers similar to the multi-layer trap system 100. The circular multi-layer trap system 450 is disposed within the container 420. The circular multi-layer trap system 450 includes circular discs similar to the layers (i.e., the conveyance layer 110, the immobilizing layer 120, and the substrate 140) of the multi-layer layer trap system 100. For example, the circular multi-layer trap system 450 may be secured to or rest upon the container base 440. The container 420 includes the container openings 430. The container openings 430 may be disposed at the bottom edge of the container 420 proximate to the container base 440, or at another location on the container. The container openings 430 allow entry of insects and/or arachnids into the container 420. The container openings 430 may include a pattern of openings and the geometry or size of the openings 430 may be selected for different regions of the world. The container openings 430 may be tapered such that the interior of the container openings 430 are smaller than the container openings 430 at the exterior of the container 420 to discourage an insect and/or arachnid from leaving the self-contained trap 400 after entering. There may also be barbs (not shown) inside the container openings 430 to discourage exiting the container 420. The circular multi-layer trap system 450 may include an attractant selected to attract certain insects or arachnids. The self-contained trap 400 may be found in a range of sizes, for example a larger size such as 5 cm in diameter, or a small size such as 1 cm in diameter. These dimensions are exemplary only and other sizes and shapes are possible. Referring to FIG. 4C, an example of a pattern of the immobilizing layer 120 is shown as manufactured, for example, by a deposition process such as an inkjet drop on demand process on a mounting layer 470. The immobilizing layer 120 is disposed in a region under the container 420. Such configuration may protect the adhesive layer from contamination, for example, from dirt or other unwanted material. Container 420 is exemplary only and other container shapes, such as the tent cover 460, rectangular, or dome housings are possible. The mounting layer 470 may be capable of housing one or more containers with a selectively printed or otherwise deposited conveyance layer 110, immobilizing layer 120 and/or attractant.

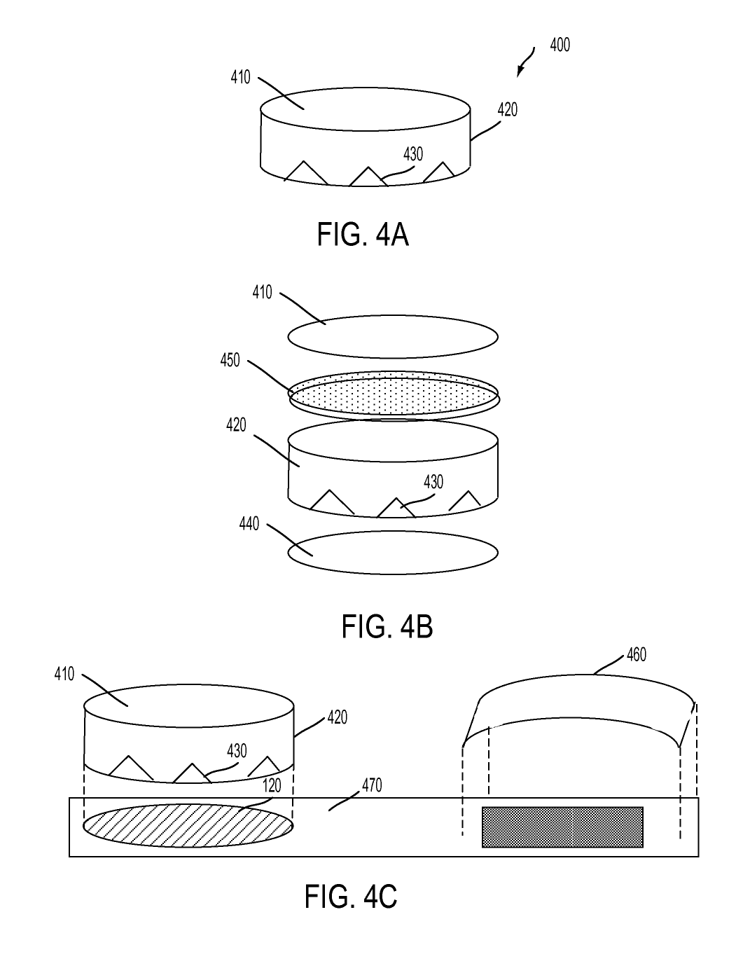

Referring to FIG. 5A-C, schematic diagrams of examples of self-contained traps are shown. FIGS. 5A -C are examples only and are not limiting of the invention as other shapes, configurations, and layers in accordance with the disclosure are possible. The self-contained trap may be a pendant, a barrel trap, or a tube trap. For example, as shown in FIG. 5A, the self-contained trap may be a pendant self-contained trap 500. The multi-layer trap system 100 is inserted into a disc-shaped housing 520 that includes an attachment ring 510. The attachment ring 510 may, for example, secure the pendant self-contained trap to an animal collar or to human clothing. As a further example, as shown in FIG. 5B, the self-contained trap may be a barrel self-contained trap 590. Referring to FIG. 5B, an example of a self-contained trap with a barrel trap housing 530 is shown. The barrel trap housing 530 may be an enclosed cylindrical container. For example, slit openings 540 may allow insects and/or arachnids to enter into the barrel trap housing 530. Slit openings 540 may be tapered to discourage insects and/or arachnids from exiting the barrel trap housing 530. The barrel self-contained trap 590 may include an emitter 550 secured to one or both ends of the barrel trap housing 530. The emitter 550 may be a cylindrical container and may include emitter openings 560. The emitter openings 530 may have a variety of shapes, including for example, a diamond, a circle, a rectangular, slits or other regular or irregular polygonal shape. The emitter 550 includes at least one or more attractants disposed within the emitter 550. The emitter 550 provides attractants in addition to the attractants in the multi-layer trap system 100. The attractants included in the emitter 550 may be unaccompanied by immobilizing compounds and thereby the inclusion of the emitters 550 may enhance the attraction capabilities of the barrel self-contained trap 590 as compared to a trap without emitters 550. Additionally or alternatively, one or more multi-layer trap systems 100 may be secured to one or both opposing ends of the barrel trap housing 530. One or more multi-layer trap systems 100 may also be disposed inside the barrel trap housing 530. The one or more multi-layer trap systems may be secured to an inner surface of the barrel trap housing 530 and/or may be loose within the barrel trap housing 530. The self-contained trap (e.g., the pendant and the barrel) may include one or more attractants at a variety of concentrations. In an embodiment, the multi-layer trap system 100 may be formed in a tube shape (e.g., with the conveyance layer 110 or immobilizing layer 120 on the outer edge) and disposed within, and coextensive with at least part of, the barrel trap housing 530.

Referring to FIG. 5C, an example of a trap collar 575 is shown. The exterior surface of the trap collar 580 and/or the interior surface of the trap collar 570 may include a multi-layer trap system 100. The adhesive and/or the mechanical fastener, as described above with regard to FIGS. 1A and 1B, may secure the multi-layer trap system 100 to the trap collar 575. The trap collar 575, may be disposed on a body part (e.g., a neck, an arm, a leg, etc.). The trap collar 575 may be extendable or may include an attachment mechanism, as described above with regard to FIG. 3, for disposition of the trap collar 575 on the body part.

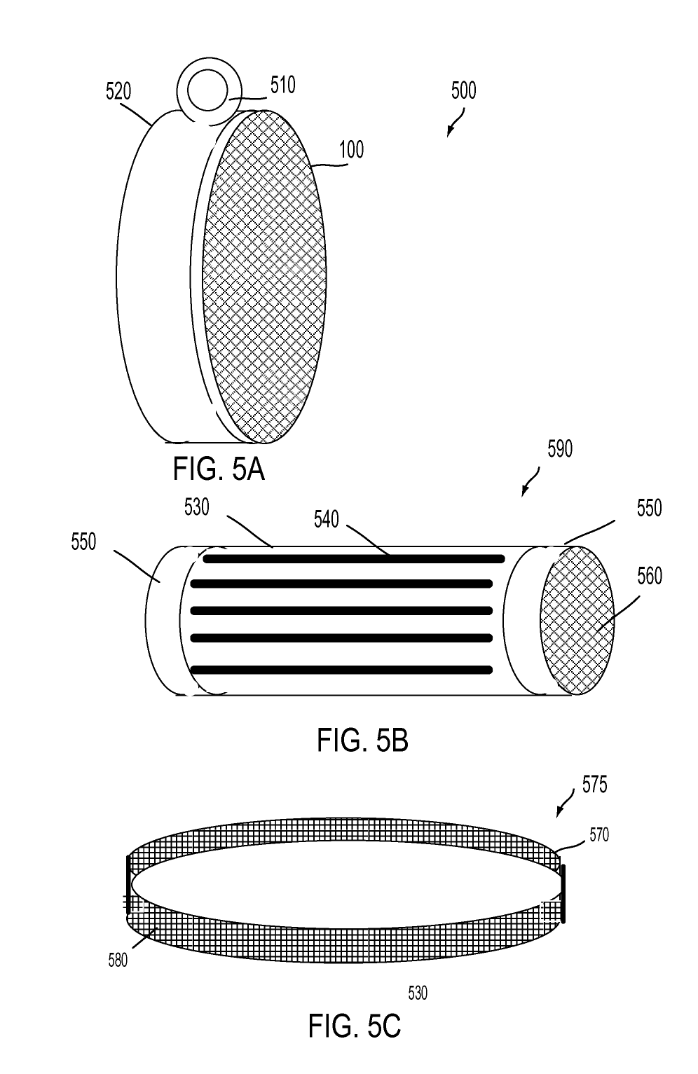

Referring to FIG. 6, an example of an animal harness with integrated multi-layer trap systems 600 is shown. One or more wearable multi-layer trap systems 200 may be secured onto an animal harness 610, for example, by Velcro™, adhesive, or a mechanical fastener. Alternatively, the base 210 can be sewn, welded or otherwise physically integrated into the animal harness 610 whereby the base 210 can act as a receiver for the multi-layer trap systems 200. Additionally or alternatively, the substrate layer 140 may be constitutive of the band 210. FIG. 6 is only an example and is not limiting of the invention as other shapes, geometries, configurations, and layers in accordance with the disclosure are possible.

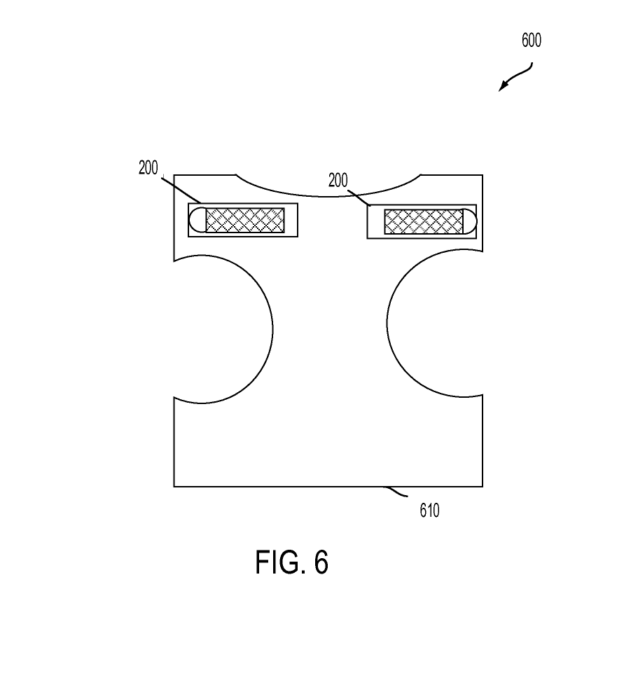

Referring to FIG. 7 an example of a clamshell case 700 with a multi-layer trap system 100 is shown. FIG. 7 is an example only and not limiting of the invention as other configurations in accordance with the disclosure are possible. The clamshell case 700 may be altered, e.g., by having components added, removed, reshaped or rearranged. The clamshell case 700 includes clamshell case openings 720, a clamshell top 710, a clamshell bottom 730, and hinges 740. The clamshell case openings 720 may be disposed on one or more exterior surfaces (e.g., top, bottom, sides) of the clamshell case 700 to allow insects and/or arachnids entry into the clamshell case 700. These clamshell case openings 720 may be tapered and/or include one or more barbs to discourage or prevent exit from the clamshell case 700 interior once the insect and/or arachnid has entered the clamshell case 700 through the clamshell case openings 720. For example, tapered clamshell case openings 720 may range from 0.95 cm to 0.32 cm at the exterior surface of the clamshell case 700 to 0.6 cm to 0.08 cm at the interior surface of the opening 720. These clamshell case openings 720 can assume various geometries including circular, oval, rectangular, triangular, or other non-regular shapes. The clamshell case openings 720 may be regularly spaced or may be spaced in a pattern conducive to the entry of particular insects and/or arachnids. The clamshell case 700 can accommodate the physical attachment of a multi-layer trap system 100 as shown. The multi-layer trap system 100 may be disposed inside the clamshell case 700 between the clamshell top 710 and the clamshell bottom 730. The clamshell case 700 may be substantially composed of a polymer (e.g.,polyurethane, polysilicone, polyethylene, polypropylene, isoprene, nylon, cellulosic-based, or combinations thereof). The clamshell case 700 may be rigid or flexible. The exterior profile of the flexible clamshell case 700 can form an arc shape from 5-360 degrees. Such a flexible clamshell case 700 may be substantially composed of a polyurethane-based or polyolefin-based thermoplastic elastomer (TPE) with up to 100% elongation capability. An exterior surface of the clamshell case 700 may be textured or roughened, for example, by a mechanical, chemical, plasma corona, deposition, or other method in order to increase the exterior surface area and provide an enhanced gripping surface for the insects and/or arachnids. The clamshell housing 700 can include one or more loops and/or one or more channels to facilitate attachment of the clamshell case 700 to a collar, harness, etc. For example, a collar may insert into pre-existing loops and/or the channels to secure the clamshell case to the collar. The hinges 740 may attach the clamshell top 710 to the clamshell bottom 730. The hinges 740 allow the clamshell case 700 to open, for example, to allow replacement of the multi-layer trap system 100 or refill and/or replacement of particular layers of the multi-layer trap system 100. In an embodiment, the multi-layer trap system 100 may exclude the conveyance layer 110 (i.e., the multi-layer trap system 100 may include the substrate 140 and the immobilizing layer 120) and the clamshell top 710 may functionally replace the conveyance layer 110.

In an embodiment, the multi-layer trap system 100 is refillable, attachable and wearable trap system with ability to attract, ensnare, immobilize, or kill a tick or other targeted walking arachnid or insect present on the surface of a host mammal Such a wearable trap may include a housing with a cavity (e.g., a clamshell, pendant, barrel, etc) and a mechanical fastener for attaching to a carrier. The housing may contain a refillable immobilizing layer 120 and/or the substrate 140 that includes a chemical-based arachnid or insect attractant. The housing may also include a receiver base layer that allows for temporary insertion or attachment of immobilizing layer 120 and/or the substrate 140. In an example, the housing may also include a porous outer layer or cover (e.g., a conveyance layer 110) and a lower receiver base layer which when co-joined forms a cavity. The housing receiver base layer includes an insertion guide or track for temporarily holding the refillable immobilizing layer in place. The housing may also contain a refillable emitter module for housing a chemical-based arachnid or insect attractant. An adhesive compound may be included with the immobilizing layer 120.

Examples of the attractants within the immobilizing layer 120 contain a single chemical compound or any combination of the following naturally occurring chemical compounds found in or produced by mammals: salt, water, acetone, nitric oxide, acetic acid, guanine, xanthine, hypoxanthine, adenine, inosine, 8-azaguanine, squalene, 2-nitrophenol, benzoic acid, butanoic acid, methylbutanoic acid, methylpropanoic acid, pentanoic acid, nonanoic acid, methyl salicylate, salicylaldehyde, hematin, carbon dioxide, octenol, ammonium carbonate, 2,6-dichlorophenol, phenylacetaldehyde, amino acids, urea, uric acid, benzaldehyde, hexanal, heptanal, pyruvate, 3-pentanone. A typical ratio of attractant chemicals within the immobilizing layer 120 includes: 1-2 parts octenol, 5-10 parts squalene, 5-10 parts nitrophenol, 10-20 parts methyl salicylate, 10-20 parts butanoic acid, 10-20 parts nononoic acid, 10-20 parts guanine, 10-20 parts xanthine.

The immobilizing layer 120 may be spatially patterned in two or three dimensions with an inkjet drop on demand deposition application or other spatially specific deposition means. In an example, the attractants may also be spatially patterned in two or three dimensions within the immobilization layer 120 with an inkjet drop on demand deposition application.

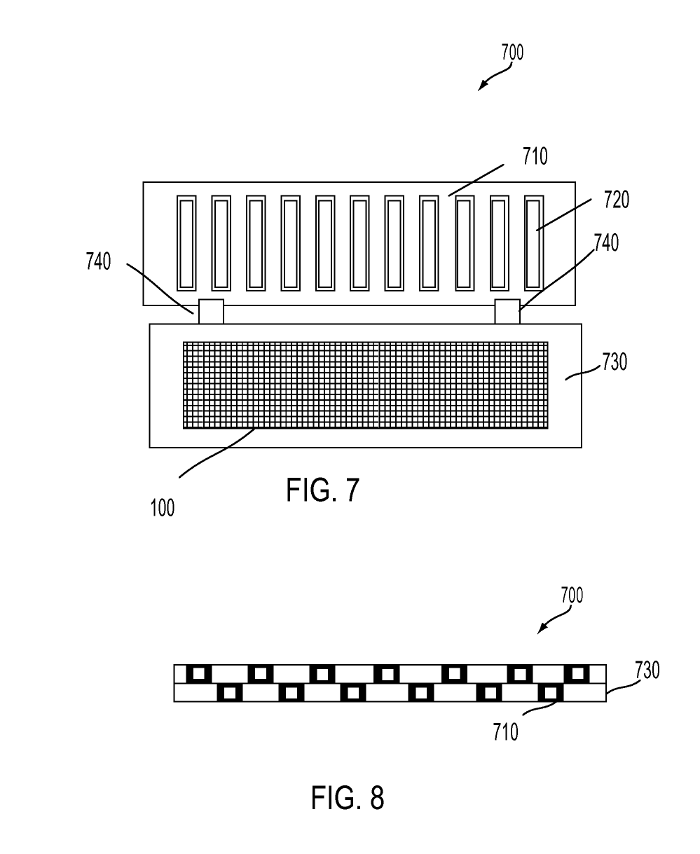

Referring to FIG. 8, an example of a side view of a clamshell case 700 in a closed position is shown. In the closed position, a space (not shown) between the clamshell top 710 and the clamshell bottom 730 may allow insertion of the multi-layer trap system 100 into the clamshell case 700. The space may be between 0.9 cm and 0.09 cm in width. Side holes 810 may allow entry of insects and/or arachnids into the clamshell case 700. These side holes 810 may be tapered and/or include the barb, similarly to clamshell case openings 720.

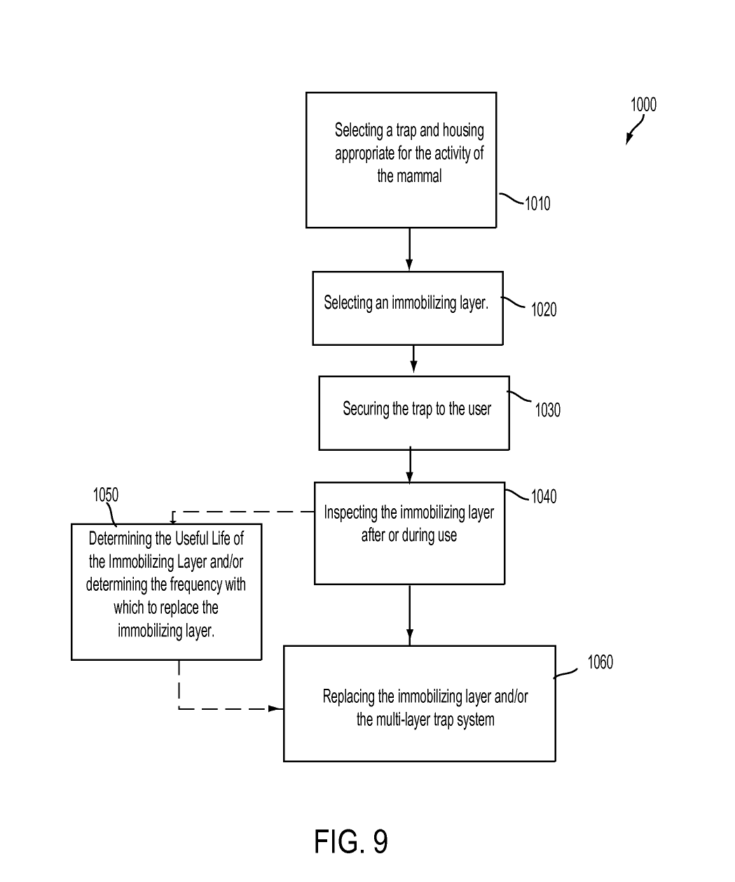

In operation, referring to FIG. 9, with further reference to FIG. 1-8, a process 1000 for using the multilayer trap system 100 on a mammal includes the stages shown. The process 1000, however, is exemplary only and not limiting. The process 1000 may be altered, e.g., by having stages added, removed, or rearranged.

At stage 1010, the method includes selecting a trap and housing appropriate for the activities of the host mammal For example, the self-contained trap 400, the wearable multi-trap system 200, or the flexible multi-trap trap system 300 may be selected. Further, the clamshell housing 700, the pendant self-contained trap 500, or the barrel self-contained trap 590 may be selected. Selecting the trap may include selecting the trap based on one or more of properties of the conveyance layer 110 (e.g., opening geometry, material etc.), the specific environment associated with a particular host mammal (e.g., long hair or fur vs. short hair or fur, exposure to water, etc.), geographic location, or the location of the trap with regard to the mammal (e.g., located on apparel, bedding, etc.).

At stage 1020, the method includes selecting an immobilizing layer. For example, the immobilizing layer 120 may be selected based on one or more of inclusion of the attractant, the type of attractant, or the geographical region of the world in which the trap will be used. As a further example, the immobilizing layer 120 may be selected based on the insects and/or arachnids (e.g., a size, shape, lifecycle, and/or a species of the insects and/or arachnids) existing in a particular geographic area such as New England, the Rocky Mountains or the desert. In an embodiment, the selected immobilizing layer can be incorporated into a multi-layer trap 100, and then assembled into the trap housing. An advantage of the multi-layer trap 100 design is to allow the interchangeability between layers and trap housings to customize the device for example, for a given activity and/or a given region and/or pest and thus improve the overall effectiveness of the system.

At stage 1030, the method 1000 includes securing the trap to the user. This may include one or more of attaching the trap as a pendant self-contained trap 500 on a collar, attaching a wearable multi-layer trap 200 on a harness, clothing, skin, or fur, attaching a flexible multi-layer trap system 300 as a 360 degree band, or attaching the trap collar. It could also include spraying on an application of the immobilizing layer 120.

At stage 1040, the method includes inspecting the immobilizing layer 120 after or during use. For example, the multi-layer trap system 100 may be viewed through the conveyance layer 110 to inspect for insects and/or arachnids trapped in the immobilizing layer 120. Alternatively, the multi-layer trap system 100 may be removed from, for example, a self-contained trap 400, a pendant self-contained trap 500, or a barrel self-contained trap 590, to inspect the immobilizing layer 120.

At stage 1050, the method optionally includes verifying the integrity of the immobilizing layer. A user may determine the useful life of the immobilizing layer and/or the frequency with which to replace the immobilizing layer. For example, excessive exposure to water can be determined with a chemically sensitive visible indicator (e.g., by determining the color of the visible indicator). In addition, other time-based and/or chemically sensitive indicators can be incorporated to reflect reduced attractant concentrations or adhesive capability for an immobilizing layer.

At stage 1060 the method includes replacing the immobilizing layer and/or replacing the multi-layer trap system. For example, the replacement tab 220 may be used to remove the immobilizing layer 120 as described above in regards to FIG. 2. As a further example, the clamshell case 700 may be opened and the multi-layer trap system 100 may be removed and replaced.

For human applications, the multi-layer trap system 100 is suitable for wearing by attaching to numerous garments, substrates, carriers or any other object adorned, carried, or transported by a person. The multi-layer trap system 100 or certain sub-components can also be integrated directly within wearable garments or substrates to provide customized, integrated wearable or attachable systems. Similarly, for domesticated or livestock mammal applications, the multi-layer trap system 100 is suitable for wearing by attaching to numerous garments, collars, substrates, carriers or any other object adorned, carried, or transported by a domesticated or livestock mammal In addition, the multi-layer trap system 100 could be built into a patch which can be integrated into a domesticated mammal's bedding, blanket, mat, or carrier. As with the custom, integrated patch systems for human applications above, the domesticated or livestock mammal multi-layer trap system 100 or its corresponding sub-components can also be integrated directly within wearable mammal collars, garments or substrates to provide customized, integrated wearable or attachable systems.

The multi-layer trap system 100 can be also configured as a dermal patch or bandage for direct application to skin for humans or fur and hair in the case of domesticated or livestock mammals. The multi-layer trap system 100 or any combination of its components can also be configured with fasteners, straps, adhesives, etc. or any other physical component to provide ancillary attachment to a human, domesticated or livestock mammal, or any garment or object adorned by a human or domesticated mammal The multi-layer trap system 100 or any combination of its components can be utilized and configured as a single use or disposable application or as a multi-use, reusable application. The multi-layer trap system 100 may be configured with non-toxic, low concentration, naturally occurring chemical or biological attractant compounds naturally produced by and found in mammals. These naturally occurring attractant compounds can be combined with other components of the multi-layer trap system 100 such as an attachable substrate, an immobilizing layer 120 for example, a gel, and a conveyance layer 110 allowing the insect and/or other targeted pest to reach the immobilizing layer 120.

The substrate layer 140 can be produced with specific patterns and/or chemical attractants to facilitate enhanced capture of the insects and/or arachnids. For example, an adhesive-free, two-dimensional pathway which narrows in width from a dimensional range defined by the length of the housing interior down to 50 microns may be manufactured by drop on demand inkjet techniques or other spatially specific deposition technique. The immobilizing layer 120 can be similarly produced with similar spatial specificity. In addition, the substrate layer 140 can be produced with spatially specific chemical attractant locations to enhance capture. The attractant spatial locations can be stand-alone islands on the substrate layer 140 or co-deposited with the immobilizing layer 120. For example, features on a layer may including narrowing spiral, narrowing channel with chemical attractant at end of channels, or pathways to three dimensional features that trap insects and/or arachnids and may use attractants and immobilizing compounds at inner most area. For example, starting at the exterior of an opening 430 of a container 420, or slit openings 540 of a barrel trap housing 530, three dimensional channels or paths may be formed with spatially specific three dimensional printing, stereo lithography, or other spatially dependent deposition method. These channels can be functionalized with attractants and/or immobilizing compounds.

The multi-layer trap system discussed herein may be made in a waterproof or water resistant configuration. Expiration indicators may also be integrated into an immobilizing layer 120 and attractants.

As used herein, including in the claims, “or” as used in a list of items prefaced by “at least one of indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.).

As used herein, including in the claims, unless otherwise stated, a statement that a function or operation is “based on” an item or condition means that the function or operation is based on the stated item or condition and may be based on one or more items and/or conditions in addition to the stated item or condition.

Other examples and implementations are within the scope and spirit of the disclosure and appended claims. Further, more than one invention may be disclosed.

The items and methods discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known structures, processes, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

What is claimed is:

1. A multi-layer trap system for disease prevention, comprising:
a substrate layer;
an immobilizing layer disposed on the substrate layer and comprising:
an immobilizing compound including at least one trapping structure; and
an attractant.

2. The multi-layer trap system of claim 1 further comprising a conveyance layer disposed on or about the immobilizing layer, wherein the conveyance layer is configured to permit an insect to travel through the conveyance layer to the immobilizing layer.

3. The multi-layer trap system of claim 2 wherein the conveyance layer is a flexible polymer comprising a plurality of trap openings.

4. The multi-layer trap system of claim 1 wherein the at least one trapping structure includes a plurality of dimensionally reducing or confining tunnels.

5. The multi-layer trap system of claim 1 wherein the at least one trapping structure includes a plurality of nautilus shapes.

6. The multi-layer trap system of claim 1 further comprising a base with an insertion guide, wherein the substrate layer is configured to be attached to the base via the insertion guide.

7. The multi-layer trap system of claim 6 wherein the substrate layer includes a replacement tab.

8. The multi-layer trap system of claim 1 further comprising a clamshell case, wherein the clamshell case includes a plurality of case openings, and the substrate layer and the immobilizing layer are disposed within the clamshell case.

9. The multi-layer trap system of claim 1 further comprising a barrel trap housing, wherein the substrate layer and the immobilizing layer are disposed within the barrel trap housing.

10. The multi-layer trap system of claim 9 further comprising an emitter disposed on the barrel trap housing.

11. A flexible multi-layer trap system for disease prevention, comprising:
a flexible band base having a first side and a second side;
a substrate layer secured to the first side of the flexible band base;
an immobilizing layer disposed on the substrate layer and comprising:
an immobilizing compound including at least one trapping structure;
an attractant; and
a flexible conveyance layer disposed on or about the immobilizing layer.

12. The flexible multi-layer trap system of claim 11 wherein the flexible band base is an openable annular ring.

13. The flexible multi-layer trap system of claim 11 wherein the flexible band base is integrated into a garment.

14. The flexible multi-layer trap system of claim 11 further comprising an adhesive disposed on the second side of the flexible band base, wherein the adhesive is configured to contact the skin of a user when the flexible multi-layer trap system is worn by the user.

15. A refillable, attachable and wearable trap system with ability to attract, ensnare, immobilize, or kill a tick or other targeted walking arachnid or insect present on a surface of a host mammal comprising:
a housing with a cavity;
wherein the housing contains a refillable immobilizing layer or substrate that includes a chemical-based arachnid or insect attractant;
wherein the housing contains a receiver base layer that allows for temporary insertion or attachment of the refillable immobilizing layer or substrate;
wherein the housing has a porous outer layer or cover and a lower receiver base layer which when co-joined forms the cavity;
wherein the receiver base layer has an insertion guide or track for temporarily holding the refillable immobilizing layer in place;
wherein the housing contains a refillable emitter module for containing the chemical-based arachnid or insect attractant; and
wherein the housing exterior has a mechanical fastener for attaching to a carrier.

16. The wearable trap system of claim 15 wherein the refillable immobilizing layer contains an adhesive compound.

17. The wearable trap system of claim 16 wherein the chemical-based arachnid or insect attractant within the refillable immobilizing layer contains a single chemical compound or any combination of the following naturally occurring chemical compounds found in or produced by mammals: salt, water, acetone, nitric oxide, acetic acid, guanine, xanthine, hypoxanthine, adenine, inosine, 8-azaguanine, squalene, 2-nitrophenol, benzoic acid, butanoic acid, methylbutanoic acid, methylpropanoic acid, pentanoic acid, nonanoic acid, methyl salicylate, salicylaldehyde, hematin, carbon dioxide, octenol, ammonium carbonate, 2,6-dichlorophenol, phenylacetaldehyde, amino acids, urea, uric acid, benzaldehyde, hexanal, heptanal, pyruvate, 3-pentanone.

18. The wearable trap system of claim 17 wherein a typical ratio of chemical-based arachnid or insect attractant within the refillable immobilizing layer is: 1-2 parts octenol, 5-10 parts squalene, 5-10 parts nitrophenol, 10-20 parts methyl salicylate, 10-20 parts butanoic acid, 10-20 parts nononoic acid, 10-20 parts guanine, 10-20 parts xanthine.

19. The wearable trap system of claim 17 wherein the chemical-based arachnid or insect attractant is spatially patterned in two dimensions within the refillable immobilizing layer with an inkjet drop on demand deposition application or other spatially specific deposition means.

20. The wearable trap system of claim 17 wherein the refillable immobilizing layer with or without attractants is spatially patterned in three dimensions with an inkjet drop on demand deposition application or other spatially specific deposition means.
